(19) United States
(12) Patent Application Publication
(10) Pub. No.: US 2019/0236732 A1
(43) Pub. Date: Aug. 1, 2019

(54) AUTONOMOUS PROPERTY ANALYSIS SYSTEM

(71) Applicant: ImageKeeper LLC, Las Vegas, NV (US)

(72) Inventors: Jerry Speasl, Las Vegas, NV (US); Mike Patterson, Sherman, TX (US); Marc Roberts, St. Louis, MO (US)

(21) Appl. No.: 16/262,708

(22) Filed: Jan. 30, 2019

Related U.S. Application Data
(60) Provisional application No. 62/624,714, filed on Jan. 31, 2018.

(51) Int. Cl. G06Q 50/16; H04L 9/32; G01C 21/20; G05D 1/00; G05D 1/10; G05D 1/02; B64C 39/02

(52) U.S. Cl. CPC G06Q 50/163; H04L 9/3247; H04L 9/3242; G01C 21/206; B64C 2201/12; G05D 1/101; G05D 1/0219; B64C 39/024; G05D 2201/0207; G05D 1/0088

(57) ABSTRACT

Media data about a property is collected via one or more unmanned vehicles having sensors, and optionally other devices as well. The unmanned vehicles are guided along paths about the property, optionally about the exterior and interior of a structure on the property, A layout of the property—optionally including a layout of the interior and/or exterior of the structure—is generated and shared. The media data and the generated layout may be certified using digital signatures, enabling verification of their source device, collection time, and authenticity.

### CROSS-REFERENCE TO RELATED APPLICATION

The present application claims the priority benefit of U.S. provisional application No. 62/624,714 filed Jan. 31, 2018 and entitled “Virtual Claim and Appraisal System,” the disclosure of which is incorporated herein by reference.

### BACKGROUND OF THE INVENTION

### 1. Field of the Invention

The present invention generally relates to gathering information about property. More specifically, the present invention relates to collecting and transforming data regarding physical space into a virtual layout for property-level intelligence, inspection, and reports.

### 2. Description of the Related Art

Property (land) surveying is a technique for evaluating a property (or land), often involving use of a number of sensors and mathematical distance/range calculations. Property surveys may be used in many industries, such as architecture, civil engineering, government licensing, safety inspections, safety regulations, banking, real estate, and insurance. Property or land surveyors may generally map features of three-dimensional areas and structures that may be of interest to a recipient entity. Such feature may include, for example, property boundaries, building corners, land topographies, damage to structures, and the like. Property surveying is traditionally an extremely costly, labor-intensive, and time-intensive process. Any human error that occurs during land or property surveying can have enormous consequences on the land's usage, which can be very difficult to resolve.

Unmanned vehicles are robotic vehicles that do not require an onboard driver or pilot. Some unmanned vehicles may be piloted, driven, or steered by remote control, while some unmanned vehicles may be piloted, driven, or steered autonomously. Unmanned vehicles include unmanned aerial vehicles (UAVs) that fly through the air, unmanned ground vehicles (UGV) that drive, crawl, walk or slide across ground, unmanned surface vehicles (USV) that swim across liquid surfaces (e.g., of bodies of water), and unmanned underwater vehicles (UUV) that swim underwater, and unmanned spacecraft. Unmanned vehicles can be quite small, as space for a driver, pilot, or other operator is not needed, and therefore can fit into spaces that humans cannot.

There is a need for improved methods and systems for autonomous property analysis.

### BRIEF DESCRIPTION OF THE FIGURES

FIG. 1A illustrates two unmanned vehicles guided about a property that includes a structure.

FIG. 1B illustrates a generated layout of the property that identifies various features of the property and structure of FIG. 1A based on media captured by the two unmanned vehicles of FIG. 1A.

FIG. 2A illustrates an unmanned aerial vehicle (UAV) guided about an interior of a structure and a user-operated camera that captures media of an exterior of the structure.

FIG. 2B illustrates a generated layout of the structure of FIG. 2A that identifies various features of the structure based on media captured by the unmanned aerial vehicle (UAV) and the camera of FIG. 2A.

FIG. 3A illustrates an unmanned aerial vehicle (UAV) guided about a ventilation system of a property.

FIG. 3B illustrates a generated layout of the ventilation system of the property of FIG. 3A that identifies a feature of the ventilation system based on media captured by the unmanned aerial vehicle (UAV) of FIG. 3A.

FIG. 4 illustrates a water damage zone identified within a map generated through analysis of multiple properties.

FIG. 5 illustrates a digital media storage and capture architecture.

FIG. 6A illustrates a first portion of a report generated based on the captured media and generated layout.

FIG. 6B illustrates a second portion of a report generated based on the captured media and generated layout.

FIG. 6C illustrates a third portion of a report generated based on the captured media and generated layout.

FIG. 7A illustrates an unmanned aerial vehicle (UAV).

FIG. 7B illustrates an unmanned ground vehicle (UGV).

FIG. 8 illustrates a control device for an unmanned vehicle.

FIG. 9 illustrates a head-mounted display for viewing media captured by an unmanned vehicle or other media capture device.

FIG. 10 illustrates security certification of digital media for verification of authenticity.

FIG. 11 is a flow diagram illustrating an exemplary method for security certification and verification of digital media.

FIG. 12 is a flow diagram illustrating an exemplary method for property analysis and layout generation.

FIG. 13 is a block diagram of an exemplary computing device that may be used to implement some aspects of the technology.

### DETAILED DESCRIPTION

Media data about a property is collected via one or more unmanned vehicles having sensors, and optionally other devices as well. The unmanned vehicles are guided along paths about the property, optionally about the exterior and interior of a structure on the property, A layout of the property—optionally including a layout of the interior and/or exterior of the structure—is generated and shared. The media data and the generated layout may be certified using digital signatures, enabling verification of their source device, collection time, and authenticity.

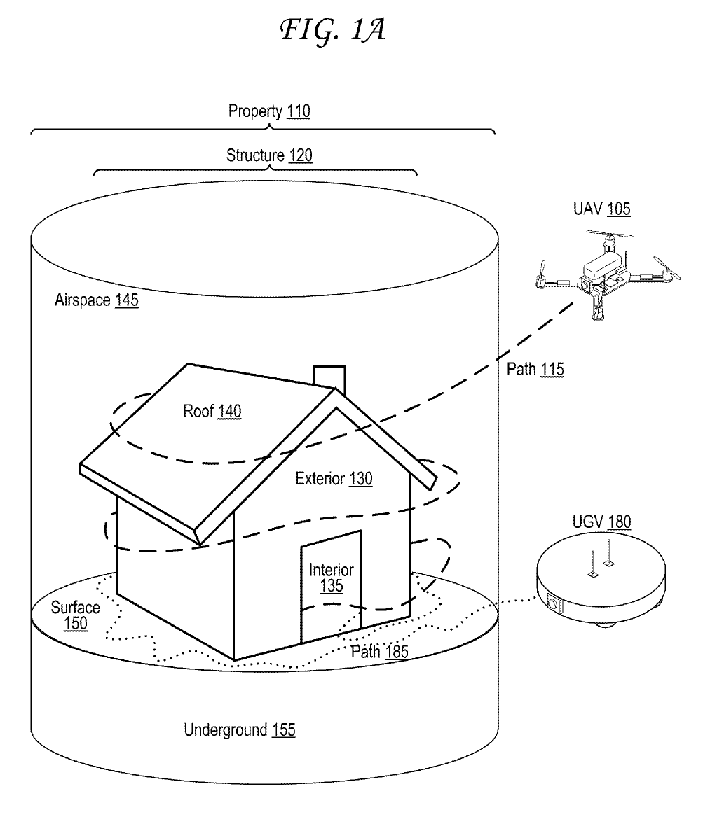

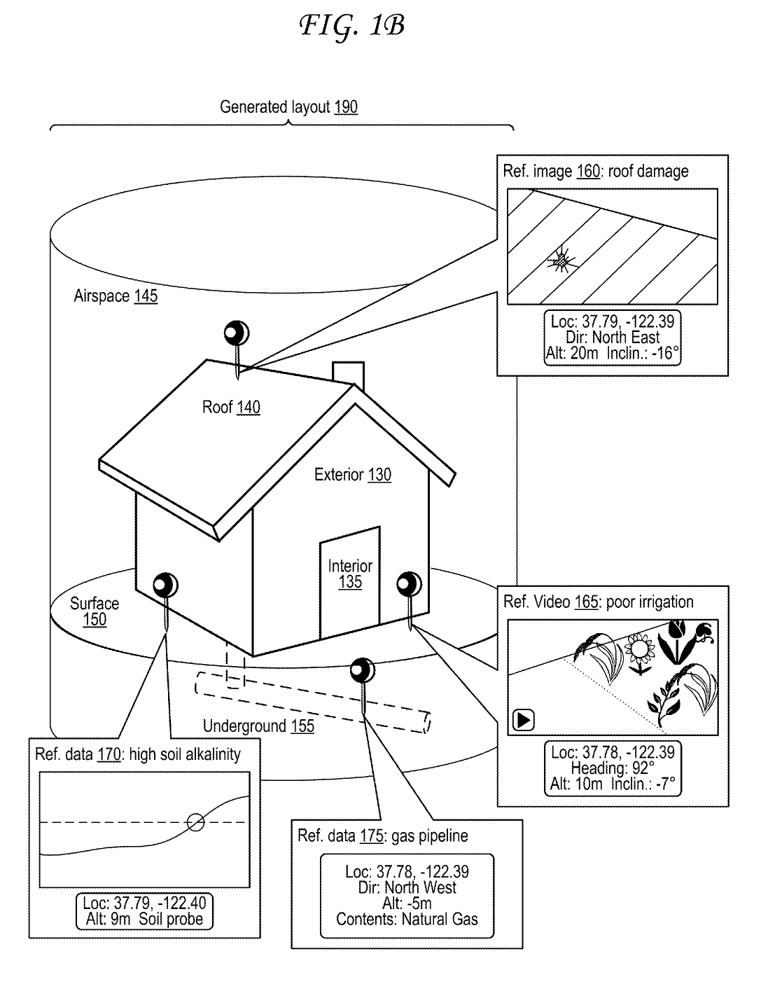

FIG. 1A illustrates two unmanned vehicles guided about a property that includes a structure.

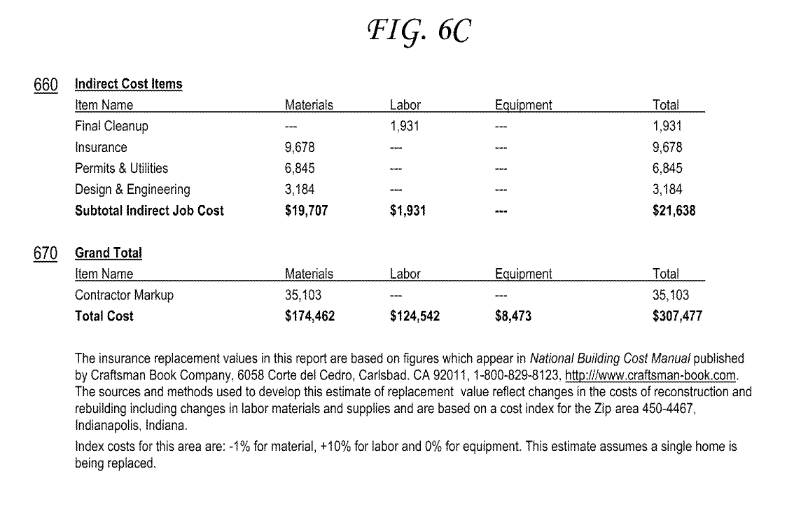

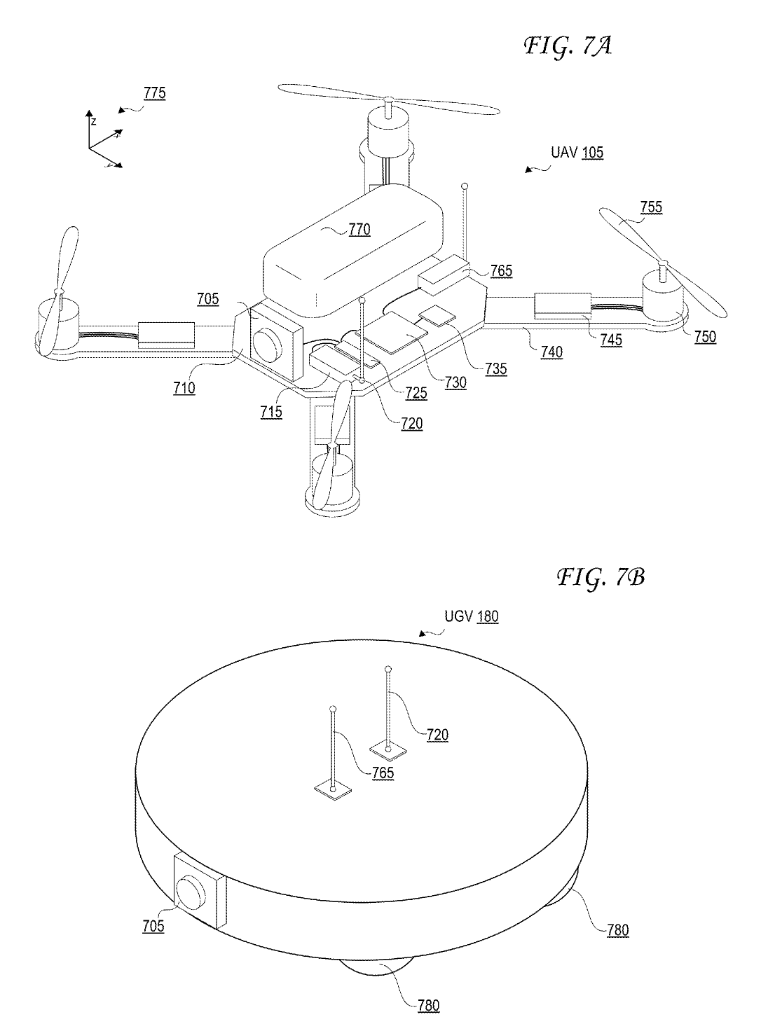

The property 110 of FIG. 1A includes a structure 120 with an exterior 130 and an interior 135 and a roof 140 (which may be considered part of the exterior 130), a ground surface 150 upon which the structure 120 is built, an underground volume 155 underneath the surface 150, and an airspace 145 over the surface 150 of the property 110. The two unmanned vehicles illustrated in FIG. 1A include an unmanned aerial vehicle (UAV) 105 that travels along a path 115, illustrated in and discussed further with respect to FIG. 7A, and an unmanned ground vehicle (UGV) 180 that travels along a path 185, illustrated in and discussed further with respect to FIG. 7B.

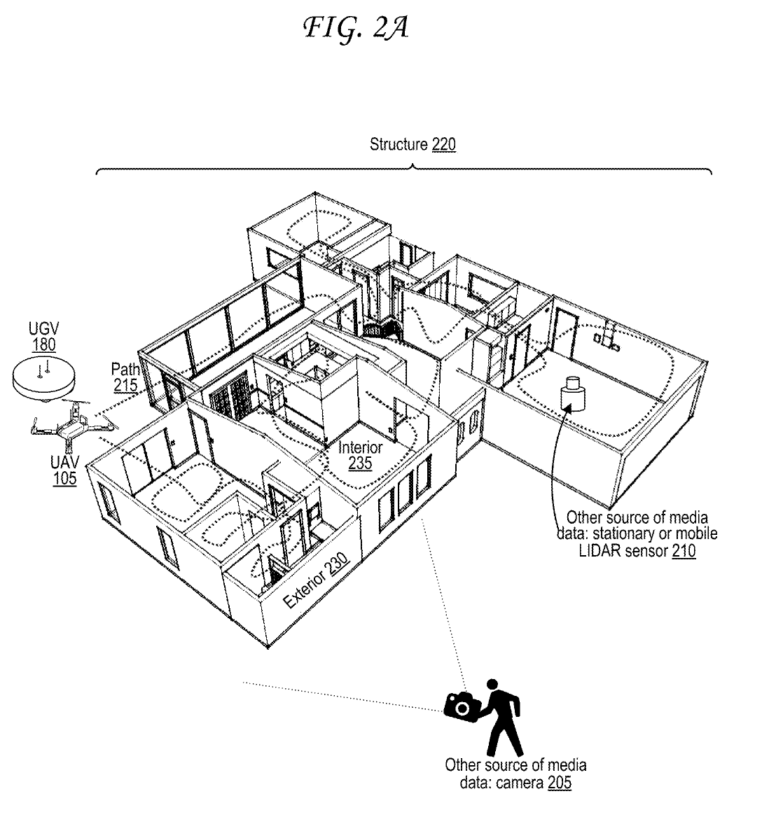

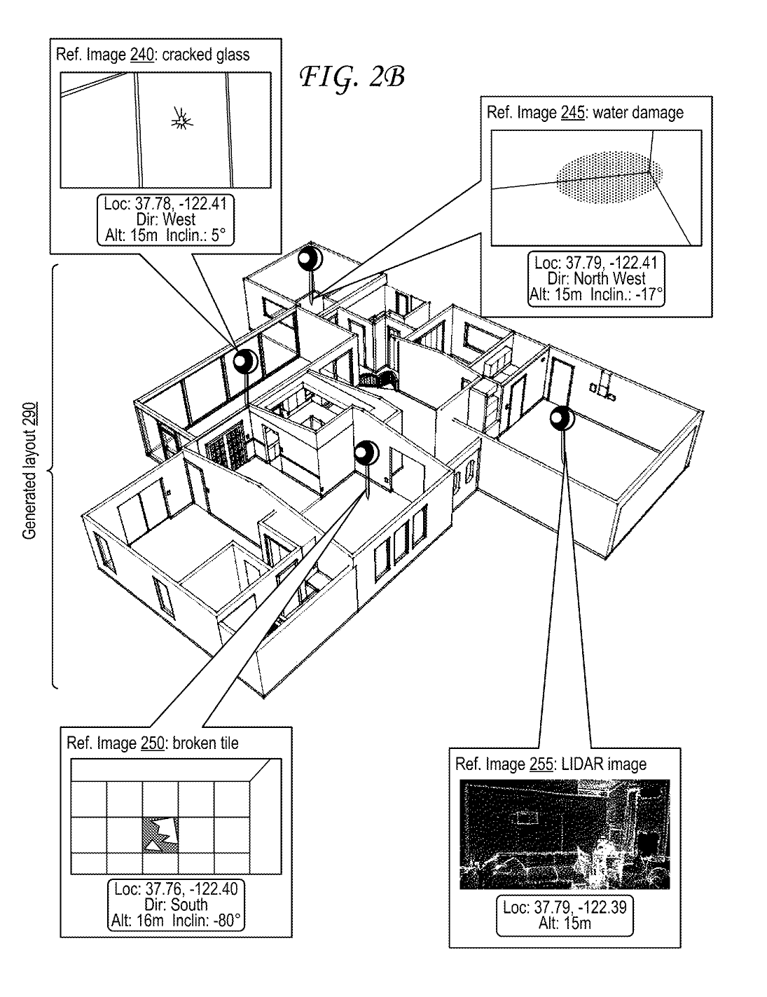

The unmanned vehicles 105 and 180 illustrated in FIG. 1A collect digital media data through various sensors of the unmanned vehicles 105 and 180 about different locations along respective paths 115 and 185 about a property 110 that includes at least one structure 120. The UAV 105 in particular flies a path 115 through the airspace 145 of the property 110 about the exterior 130 of the structure 120 (including about the roof 140), over the surface 150 and eventually into the interior 135 of the structure. Along the way, the UAV 105 captures media data at many locations along its path 115 using an array of sensors of the UAV 105. The UGV 180 drives a path 185 over the surface 150 around the structure 120, may test soil at the surface 150 and underground 155 at various points along the path 185 while outside the structure 120, and enters the interior 135 of the structure 120. Once the unmanned vehicles 105 and 180 are in the interior 135 the structure 120, they may map or model a virtual layout of the interior 135 as discussed further with respect to FIG. 2A and FIG. 2B.

Digital media data gathered by the sensors of the UAV 105, the sensors of the UGV 180, and optionally other sensors may be combined, for example using a space mapping algorithm, to generate a two-dimensional or three-dimensional layout or model 190 of the property 110 and the structure 120 within it as illustrated in and discussed further with respect to FIG. 2B. The digital media may include, for example, photos or videos from cameras, range measurements or range “images” or range “videos” from a range sensor, outputs of any other sensor discussed with respect to FIG. 7A, FIG. 7B, or FIG. 13, or combinations thereof. Range sensors may include sonic range sensors, such as sonic navigation and ranging (SONAR) or sonic detection and ranging (SODAR) sensors. Range sensors may include electromagnetic range sensors such as laser rangefinders or electromagnetic detection and ranging (EmDAR) sensors such as radio detection and ranging (RADAR) sensors or light detection and ranging (LIDAR) sensors. Range sensors may include proximity sensors.

Other sensors, such as thermometers, humidity sensors, or other environmental sensors may be used as well, and their data may be identified in the layout 190 as illustrated in and discussed with respect to FIG. 1B. Data of other types may be gathered, either through sensors or from network-based data sources, such as data regarding crime, weather, prices, property title, property tax details, property ownership history, property use history, property zoning history, radioactivity history, water quality, earthquake faults, sink holes, solar details and angles, underground details, water quality, sea level, sea level changes, insects issues, local wildlife, altitude and elevation data, flood history, airspace information, air traffic patterns, property history, toxic history and maps, traffic history, or combinations thereof.

The path 115 of the UAV 105, and the path 185 of the UGV 180, may be set by a human being such as via remote control, may be autonomously plotted or guided to automatically cover as much of the property 110 as possible and to automatically go into areas that are not yet mapped or laid out, or may be semi-autonomous, for example autonomously plotted or guided in between human-set checkpoints or waypoints, or some combination thereof. A combination, here, may entail handoffs between these types of plotting or guidance, for example part of the path 215 being guided remotely while a remainder of the path 215 is guided autonomously or semi-autonomously. When a property 110 includes water or another liquid, unmanned surface vehicles (USV) that swim across the surface of the water or other liquid, and unmanned underwater vehicles (UUV) that swim underwater or under the surface of the liquid, may be used similarly, with remote, autonomous, or semi-autonomous plotting or guidance of paths. Data, such as images or topography data, from unmanned spacecraft or high-altitude UAVs may also be used even though such unmanned vehicles might be outside of the property 110 or even the airspace 145.

FIG. 1B illustrates a generated layout of the property that identifies various features of the property and structure of FIG. 1A based on media captured by the two unmanned vehicles of FIG. 1A.

The generated layout 190 of FIG. 1B includes representations of each aspect of the property 110, including the exterior 130 of the structure 120, the roof 140 of the structure 120 the interior 135 of the structure 120, the surface 150, the underground 155, and the airspace 145. In some cases, the generated layout 190 may be missing layout details of certain areas where not enough media data was captured—for instance, if the UAV 105 was never able to fly into the interior 135 because the entryway was closed, then the layout 190 of the property may lack any or most modeling or layout detail of the interior 135.

The generated layout or model 190 may include various “references” or “links” or “hyperlinks” or “pointers” at specific locations within the layout 190 that allow a user viewing the layout 190 to view the original media data captured at the corresponding location within the actual property. Thus, a user can click, touch, or otherwise interact with a specific location the layout 190 to bring up a photograph or a video captured by the UAV 105, UGV 180, or another sensor from which media data was captured and used to generate the layout 190 or to supplement the layout 190 with localized data, such as data regarding water quality or soil sample analysis at a particular location within the property 110.

For example, a first reference 160 is a reference image 160 identifying damage to the roof 140. The UAV 105 or UGV 180, or a server or other computer system 1300 that the UAV 105 or UGV 180 sends its media data to upon capture, may automatically identify irregularities in the property such as damage, and automatically mark those areas with reference images such as the reference image 160. Capture data associated with the reference image 160 shows it was captured at latitude/longitude coordinates (37.79, −122.39), that the capture device was facing north-east at the time of capture (more precise heading angle data may be used instead), that the capture device was at an altitude of 20 meters when this image 160 was captured, and that the inclination of the capture device was −16 degrees at capture.

Another reference 165 may be a reference video 165 showing an area with poor or improper irrigation, where plants are shown growing well on the right side of a dotted line and no plants are visible growing on the left side of the dotted line. A play button is visible, which may for example play a video of the plants on the right being watered while the left side is not watered or is watered improperly. Capture data associated with the reference video 165 shows it was captured at latitude/longitude coordinates (37.78, −122.39), that the capture device was facing a heading of 92 degrees at the time of capture, that the capture device was at an altitude of 10 meters when this video 165 was captured, and that the inclination of the capture device was −7 degrees at capture.

Another reference 170 may be reference data 170 from a localized soil analysis showing an area at which the soil at the surface 150 and underground 155 has high soil alkalinity as shown by a line graph of soil alkalinity with the line exceeding a threshold alkalinity level identified by a horizontal dashed line at a circled point in time. Capture data associated with the reference data 170 shows the soil analysis was captured at latitude/longitude coordinates (37.79, −122.40), that the soil probe capture device was at an altitude of 9 meters when this data 170 was captured. The soil probe may have been used by the UAV 105 or UGV 180, for example, or may have been captured by another system, such as an internet-of-things (IOT) networked device whose data was accessible when generating the layout 190.

Another reference 175 may be reference data 175 identifying existence of a gas pipeline within the underground volume 155 of the property 110, as captured using ground-penetrating radar (GPR) or another subsurface imaging technology, for example used by the UAV 105 or UGV 180. The reference data 175 identifies a location for the gas pipeline being latitude/longitude coordinates (37.79, −122.40), that the gas pipeline goes in a northwest at least at the measured location, that the altitude of the gas pipeline is 5 meters below sea level (−5 meters), and that the gas pipeline appears to carry natural gas. While no image is included in the reference data 175 as shown in FIG. 1B, an image produced by the GPR, such as a radargram image, may optionally be included in similar situations.

Other reference data or reference media not illustrated in FIG. 1B may nonetheless also be included. For instance, reference data may identify expected or observed air traffic patterns through and around the airspace 145, or at and around the nearest airport to the property 110. Reference data may identify expected or observed smoke or smog or other air pollution measured in the airspace 145, for example in the form of an air quality index (AQI) or air quality health index (AQHI) or particulate matter (PM) index, which may be caused by nearby sources of pollution, such as airports, factories, refineries, vehicles, streets, highways, landfills, wildlife, and the like. Reference data may identify expected or observed smells or odors in the property 145, for example due to any of the sources of pollution discussed above in or near the property 110. Reference data may identify expected or observed levels of pollen, dander, or other common biological and synthetic allergens and irritants. Reference data may identify expected or observed levels of flu or other illnesses in or around the property 110. Reference data may identify an expected or observed ultraviolet index (UVI) identifying danger from the sun's ultraviolet (UV) rays in or around the property 110. Reference data may identify expected or observed levels of rainfall, expected or observed levels of humidity, expected or observed dew point, expected or observed visibility levels, expected or observed air pressure, and other expected or observed environmental parameter levels. Reference data may identify presence of underground or above-ground power lines, transmission lines, transformers, generators, power plants, wind turbines, solar panels, or other electrical equipment. Reference data may identify presence of underground or above-ground cable lines, internet data lines, fiber optic data lines, broadband lines, or other data line equipment.

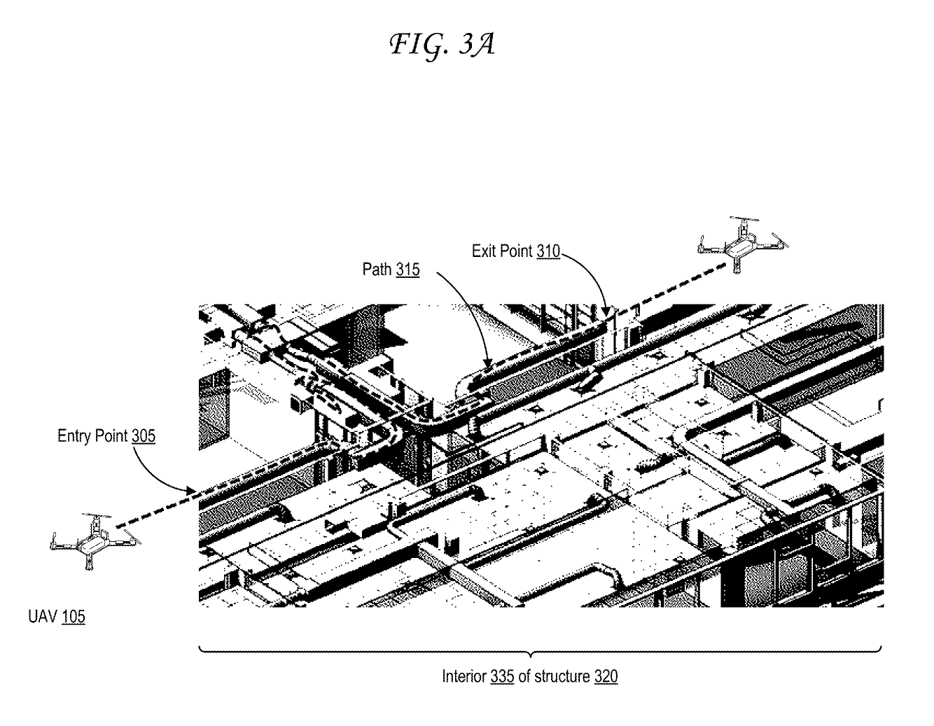

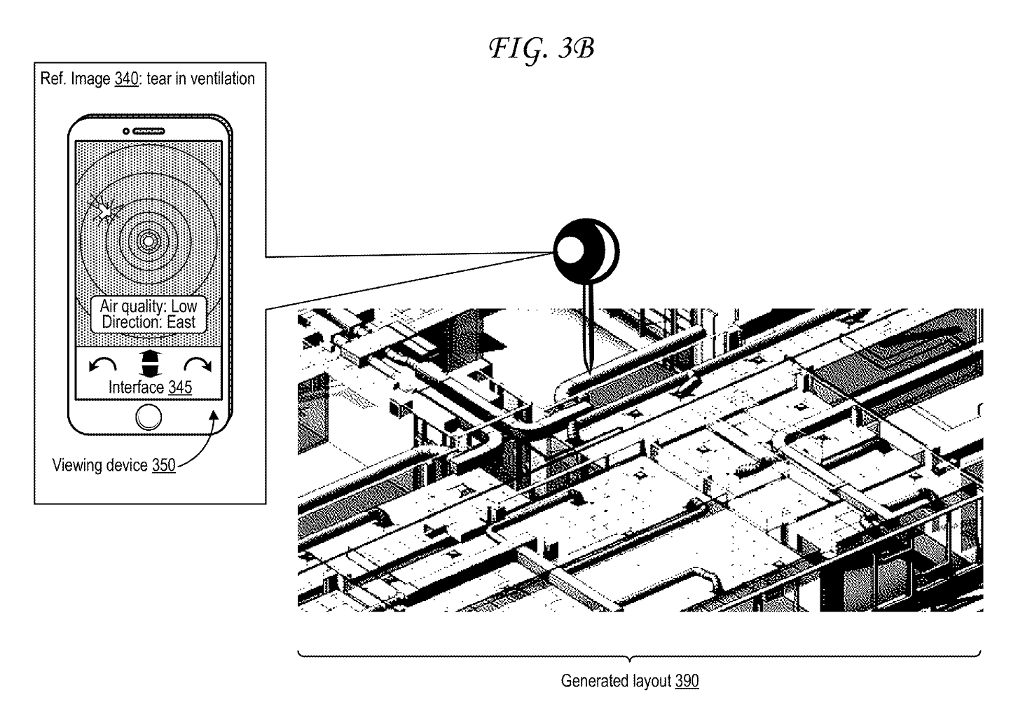

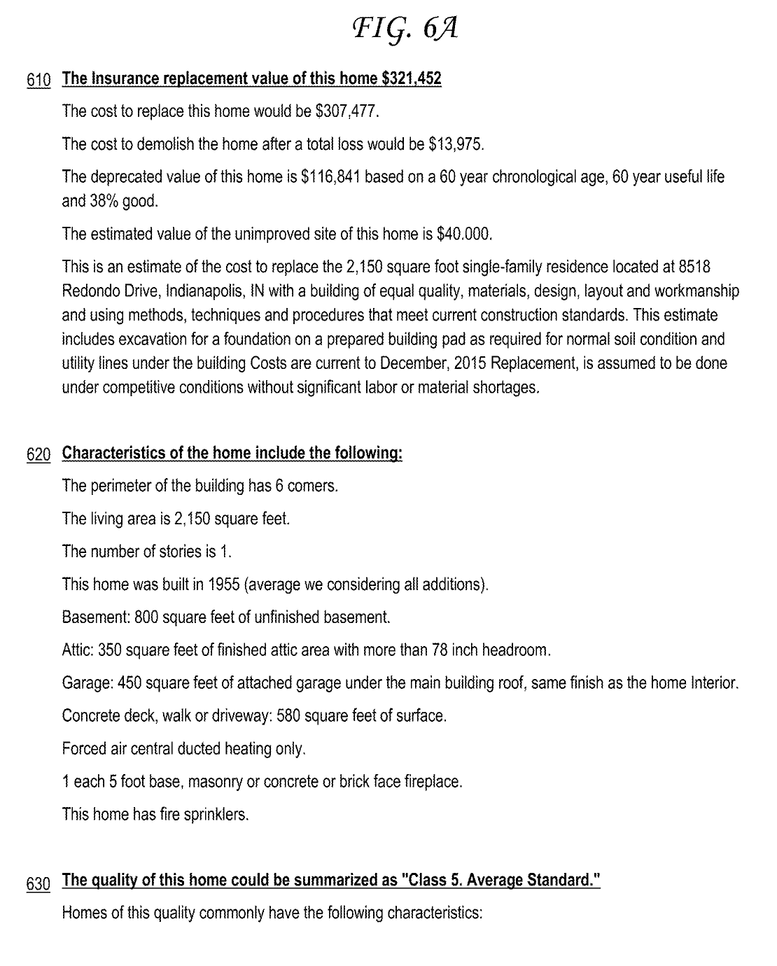

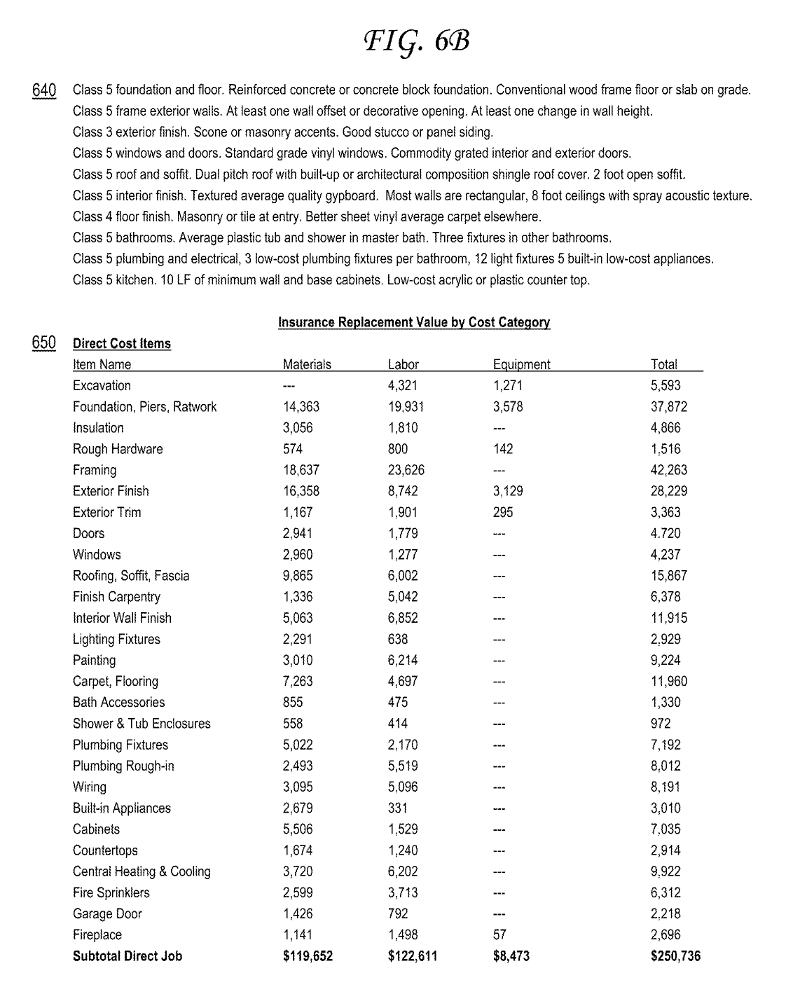

Generation of a layout 190 as shown in FIG. 1B using media captured by sensors of unmanned vehicles or other sensors as in FIG. 1B may be used by a computer system 1300 such as a server generate various reports, such as the one in FIG. 6A and FIG. 6B and FIG. 6C, which may be useful for property level intelligence in various industries, such as insurance, property claims, casualty loss, property appraisals, land surveying, property valuations, property walkthroughs, property sales, real estate, government licensing, and the like. Use of unmanned vehicles allows benefits of being able to go into areas that a human would be unable to go into, such as the cramped ventilation shaft of FIG. 3A, or would be unsafe to go into, such as a highly radioactive power plant in which a defect must be detected and fixed.

FIG. 2A illustrates an unmanned aerial vehicle (UAV) guided about an interior of a structure and a user-operated camera that captures media of an exterior of the structure.

The UAV 105 of FIG. 2A travels about a path 215 through the at least a majority of the interior 235 of a structure 220. A user with a camera 205 captures images of at least portions of the exterior 230 of the structure 220 while walking about the exterior 230 of the structure 220. A stationary or mobile (e.g., self-propelled) light detection and ranging (LIDAR) sensor 210 is also present in a particular room in the interior 235 of the structure.

Like the autonomous vehicles in FIG. 1A, the UAV 105 of FIG. 2A may plot or be guided on its path 215 remotely, autonomously, semi-autonomously, or some combination thereof. While a UGV 180 can also be used in the UAV 105's place (or additionally) as illustrated in FIG. 2A, a UAV 105 may provide some advantages over a UGV 180, such as being able to use windows, chimneys, ventilation passages, or other alternative openings other than ordinary doorways to enter and/or exit the structure 220, or to navigate through the interior 235 of the structure 220.

The UAV 105 of FIG. 2A—or any other unmanned or autonomous vehicle—may also include and execute instructions corresponding to pathfinding algorithms that can be used to navigate through the layout 290 and avoid walls and other obstacles once the layout 290 is at least partially generated. For example, if the UAV 105 examines the dimensions of an exterior of the structure 220, and then starts mapping the layout of the interior 235 of the structure 220, it can determine based on the exterior dimensions that a particular area—such as a particular corner of the structure or a particular room—has not yet been mapped and incorporated into the layout. It can then use a pathfinding algorithm with what it has so far of the layout 290 to find its way to the unmapped area to scan it with its sensors and integrate it into its generated layout 290 mapping the structure 220. A pathfinding algorithm can also help the UAV 105 find its way to an entrance or exit of the structure 220 in order to exit the structure 220 once mapping the structure 220 into the generated layout 290 is complete. Pathfinding algorithms that might be used here may include breadth-first search algorithm, depth-first search algorithm, Dijkstra's algorithm, A* search algorithm, hierarchical path finding, D* search algorithm, any-angle path planning algorithms, or combinations thereof. Multi-agent pathfinding may also be used where multiple unmanned vehicles are used in tandem to avoid collisions.

Additional data can be automatically processed and combined with the data collected here. For example data can be collected using digital cameras, clipboards, paper forms, MLS website and tape measures. Data can be collected from various sources for potential for increased risk to water property locations, air traffic, current and predictive crime mapping, current flood risk and past flood historical locations and depths, solar efficiency of the property to produce solar power, internet service speeds available by what service, cellular service signal strength, underground utilities, age, fittings, gas valves, product recalls of defective natural gas shutoff valves, property sink hole locations, mapping property to the nearest earthquake fault line, property records, history, tax lien search, title searches, federal building code records, state building code records, municipal building code records, local building code records, building code record verifications and approvals, tax liens, police incident report histories, crime reports, ground quality reports, earthquake and fault line reports, air quality reports, water quality reports, reports of nearby industries, reports of nearby air/ground/water pollutants (airports, factories, refineries), property measurements, structure measurements, physical conditions, sales records, and comps for properties that are considered similar in size and location to the property.

Data collected may also be from navigation satellites incorporating L3, L4 signals, virtual sensors; drones, aircraft, satellites, mobile digital devices, telematics, holographic, connected home data supported the cloud repository and by the enhanced 3rd party data will form an automated system to generate a completed, secure, property level intelligence appraisal system describing property values, certified property geo location, visualization media, market trends, property conformity information, property risks, usage history for heating systems, usage history for cooling systems, usage history for predictive sales price predictions, and appraised value on a specific date. Data collected may also include incorporation of virtual spatial solutions and telematics from connected home system, social media sources, property purchasing websites, property rental websites, cellular network data, wired home network data, doorbell systems, home security systems, virtual sensors, alarms, autonomous vehicles, drones, planes, internet of things (TOT), communications systems, cable etc. which provide true and accurate unmodifiable/immutable certified facts and deliver instant actual digital evidence information, visualization, situational awareness, precise 3D location, elevation, understanding and awareness of property level intelligence for virtual handling of claims, appraisals, and valuations.

FIG. 2B illustrates a generated layout of the structure of FIG. 2A that identifies various features of the structure based on media captured by the unmanned aerial vehicle (UAV) and the camera of FIG. 2A.

Like the generated layout 190 of FIG. 1B, the generated layout 290 of FIG. 2B includes references to images and other data. Reference image 240 is an image of a cracked pane of glass automatically identified within the captured media, and captured at latitude and longitude coordinates (37.78, −122.41) while the capture device (UAV 105) faced west at an altitude of 15 meters and an inclination of 5 degrees. Reference image 245 is an image of water damaged walls and floor automatically identified within the captured media, and captured at latitude and longitude coordinates (37.79, −122.41) while the capture device (UAV 105) faced north-west at an altitude of 15 meters and an inclination of −17 degrees. Reference image 250 is an image of a broken tile in a tiled floor or countertop automatically identified within the captured media, and captured at latitude and longitude coordinates (37.76, −122.40) while the capture device (UAV 105) faced south at an altitude of 16 meters and an inclination of −80 degrees. Reference LIDAR image 250 is a LIDAR range-image captured using the stationary LIDAR sensor 210 at an altitude of 15 meters.

In some cases, a user might walk through the structure 220 wearing an augmented reality headset or otherwise viewing an augmented-reality viewing device after having generated the layout 290. Alternately, a user wearing a virtual reality headset or otherwise viewing a virtual reality or telepresence viewing device may virtually traverse the layout 290. As the user traverses the structure 220 or layout 290, the reference images identified in FIG. 2B may appear, superimposed, over the structure 220 (in augmented reality) or layout 290 (in virtual reality) where appropriate. In some cases, the user can also bring up other media, such as other images, captured of areas that were not automatically flagged as important reference data like those flagged in FIG. 2B, in the same way automatically or upon request (e.g., by pressing a button or otherwise inputting a particular command).

FIG. 3A illustrates an unmanned aerial vehicle (UAV) guided about a ventilation system of a property.

The interior 335 of the structure 320 of FIG. 3A is a complex ventilation system that a human being could not fit into inside. Thus, small UAV 105 that is autonomously guided to carefully traverse the area without bumping into anything is a perfect way to navigate such an environment without causing any damage to the structure 320, as might occur using any other method of traversal. The UAV 105 enters the ventilation system (the interior 335 of the structure 320) via an entry point 305, travels along a path 315 indicated by a dashed line, and exits the ventilation system (the interior 335 of the structure 320) via an exit point 310. The UAV 105 captures media data through its sensors at multiple locations along the path 315.

FIG. 3B illustrates a generated layout of the ventilation system of the property of FIG. 3A that identifies a feature of the ventilation system based on media captured by the unmanned aerial vehicle (UAV) of FIG. 3A.

The generated layout 390 of FIG. 3B is generated based on the media data captured by the sensors of the UAV 105 while it travels along the path 315 in FIG. 3A. In the case of FIG. 3B, the sensors of the UAV 105 include at least one camera, as a reference image 340 is identified showing a location at which a tear in the ventilation was automatically detected within the media. The direction of the capture device (UAV 105) is identified as east at the time of capture, and the air quality or dust level as identified using an air quality sensor of the capture device (UAV 105) is identified as low, likely due to the tear in the ventilation.

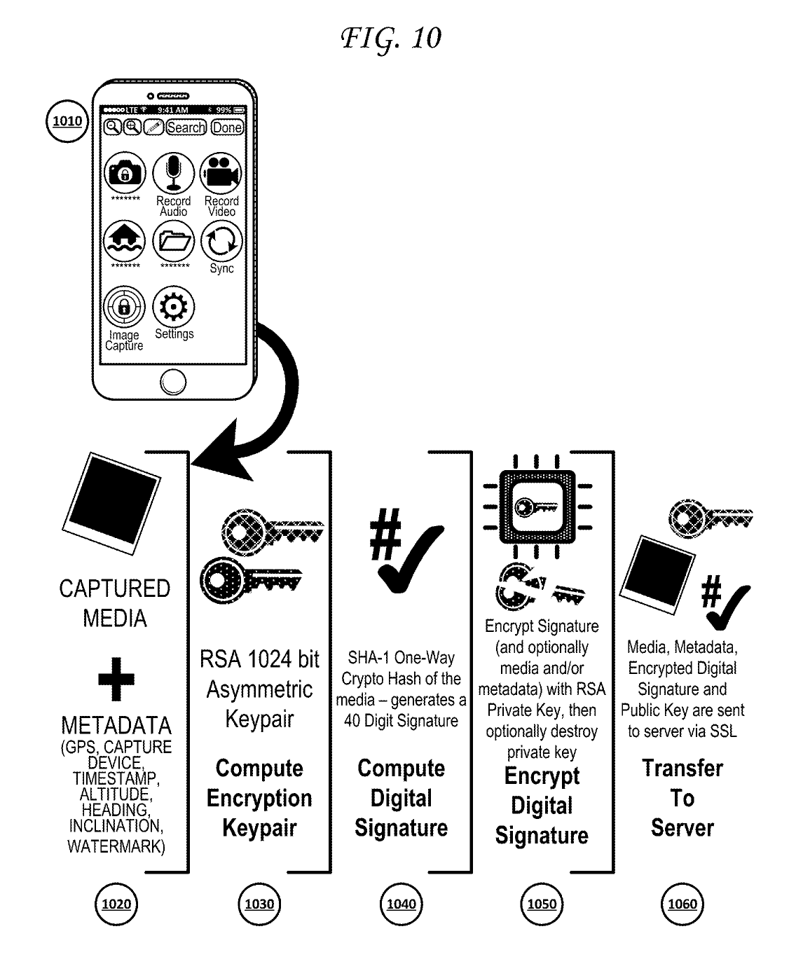

In the example of FIG. 3B, the reference image 340 is displayed via a controller and viewing device 350 along with an interface 345. The viewing device 350 is a computing device 1300 such as a smartphone, tablet, laptop, or other mobile device. The interface 345 includes an arrow forward, an arrow backward, and arrows turning left and right, respectively. The arrow forward in this interface 345 can “progress” or “move” the view output by the viewing device 350 “forward”—that is, further through the ventilation in the direction that the image is facing (east). In contrast, the arrow backward in this interface 345 can “progress” or “move” the view output by the viewing device 350 “backward”—that is, further through the ventilation west, the direction opposite the direction the image is facing (east). The arrow left can rotate the view left (north) and the arrow right can rotate the view right (south) relative to the direction that the image is facing (east). While the viewing device 350 is illustrated as a smartphone in FIG. 3B, it may be a virtual reality or augmented reality head-mounted display 900 such as the one in FIG. 9, or any other display system 1370 discussed with respect to FIG. 13.

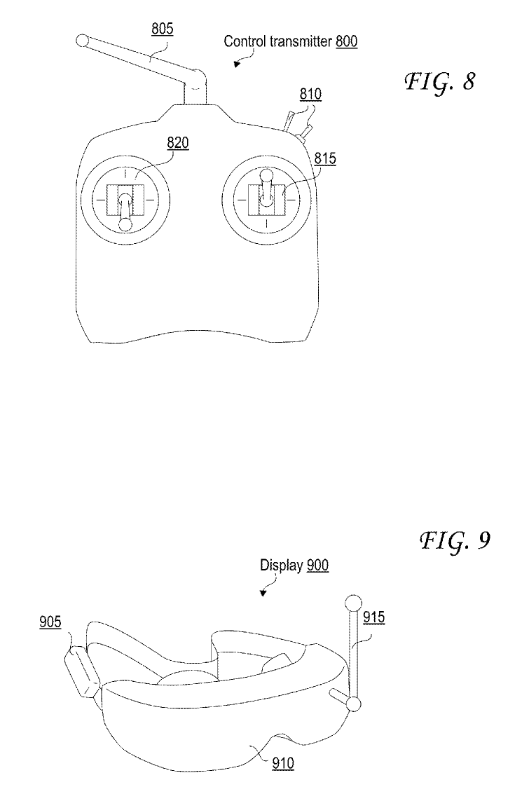

Additionally, while the interface 345 can “walk-through” the layout after capture of the media, it can also be used to control the UAV 105 as it is flying through the interior 335 of the structure 320 in FIG. 3A, with the arrows serving to control the movement and turning of the UAV 105 in a similar manner to control transmitter 800 of FIG. 8.

While this “walk-through” interface 145 is only illustrated with respect to the generated layout 390 of FIG. 3B, it should be understood that similar interfaces may be used with other generated layouts, such as the generated layout 190 of FIG. 1B or the generated layout 290 of FIG. 2B.

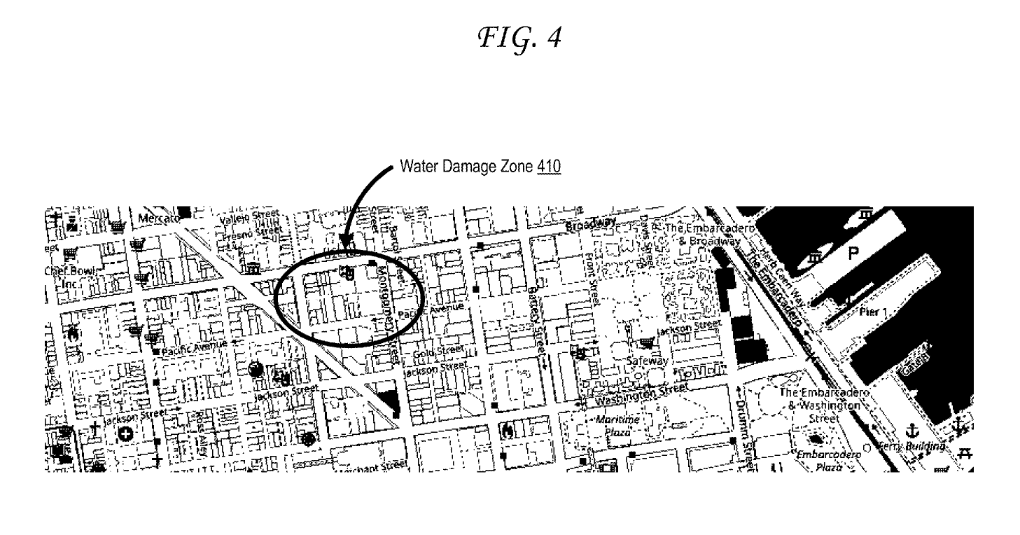

FIG. 4 illustrates a water damage zone identified within a map generated through analysis of multiple properties.

In FIG. 4, the property 110 in question is a region of a city. A water damage zone 410 is identified within the city, identifying a city block in which water damage was identified as pervasively occurring or especially likely based on property analysis of the type shown in FIG. 1A, 1B, 2A, 2B, 3A, 3B, and the like.

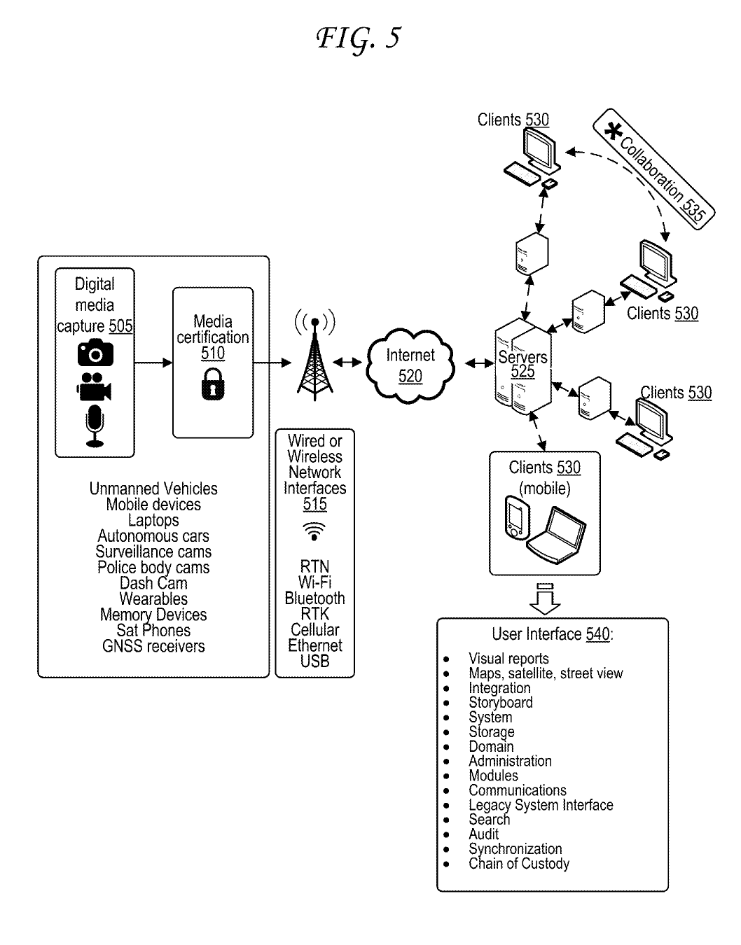

FIG. 5 illustrates a digital media storage and capture architecture.

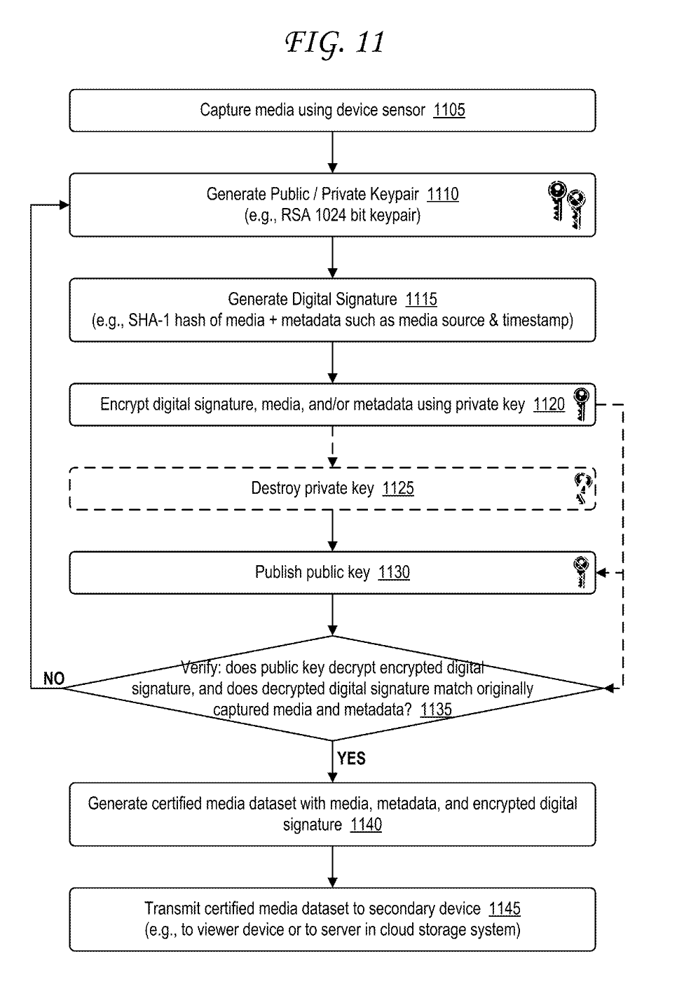

The digital media storage and capture architecture of FIG. 5 begins with digital media capture 505 and media certification 510, both of which may be performed by a number of devices, including but not limited to unmanned and/or autonomous vehicles, mobile devices, smartphones, laptops, surveillance cams, body cameras, dash cam, wearable devices, storage devices, satellite phones, GNSS receivers, computing devices 1300, or combinations thereof. Digital media capture 505 may include capture of image data using still image cameras, capture of video data using video cameras, capture of 360 degree footage using 360 degree cameras, capture of audio using microphones, capture of any other type of media data discussed herein using any other sensor type or combination of sensors discussed herein, or a combination thereof. Media certification 510 is described further herein in FIG. 10 and FIG. 11.

The captured media data, once certified, is then automatically sent through the internet 520 using wired or wireless network interfaces 515 to one or more servers 525 that serve as a cloud storage and application execution engine. The servers 525 can automatically store and catalogue public keys used in the media certification 510 process, or that task can be shifted to a separate authentication server and/or certificate authority (CA). The servers 525 can file, convert, verify authenticity using the public key from the media certification 510, and organize the media data in various ways, for example by reading location metadata and grouping images by area (room A in interior of structure, room B in interior of structure, front of exterior of structure, rear of exterior of structure, roof, etc.). The servers 525 can ensure the digital media data is filed, stored and accessed through the web in a systematic or serialized format constant with image identification formed with the image capture device (as seen on the right side of FIG. 5).

The servers 525 can then answer requests from client devices 530 for the certified media data, and may provide the certified media data to the client devices through wired or wireless network interfaces, optionally through other servers. Some clients may then share the certified media data during collaborations 535. Various user interfaces 540 and related functionality may be generated and run on the client devices 530, the servers 525, or some combination thereof, including but not limited to: visual reports, maps, satellite, street view, integration of media together with various documents, storyboarding of media along a timeline, system, storage, domain, administration, modules, communications, legacy system interfaces, searching, filtering, auditing, authenticity verification, source verification, synchronization, chain of custody verification.

In some embodiments, the image capture device can first synchronize its image and/or sensor data with a second device. For example, a camera device (e.g., a digital point-and-shoot camera) may first be required to synchronize its data with a user device such as a smartphone or wearable device, which can then form a connection to the internet/cloud system.

The internet/cloud system 525 can include one or more server systems 525, which may be connected to each other. In one embodiment, this internet/cloud system is a wireless multiplexed system for securely storing digital data to and from mobile digital devices. In another embodiment, the digital data (e.g., images, reports) are securely held in one central place, either by a hardware memory device, server, or a data center. Once the data is in the internet/cloud system 525, it may be accessible through a web portal. This web portal may include image-editing tools, worldwide access, and collaboration mechanisms available to its users. Security, digital signature, watermarking, encryption physical access, password credentials area can be utilized throughout the system. Original digital data can be confirmed, saved and protected though various technologies and system controls.

FIG. 6A illustrates a first portion of a report generated based on the captured media and generated layout.

This report includes, for example, an insurance analysis 610 identifying or estimating approximate insurance replacement value, demolishing cost, depreciated value, sale value, of a home or property or structure. The report also identifies or estimates various characteristics 620 of the home or property or structure, such as a measured or estimated perimeter, living area, basement/attic area, number of stories, age deck/driveway area, ventilation/heating/cooling, sprinklers, fireplaces and the like. The report includes a quality grade 630 for the home or property or structure (e.g., “Class 5, Average Standard”).

FIG. 6B illustrates a second portion of a report generated based on the captured media and generated layout. In particular

A list of characteristics that the quality grade 630 is based on is identified in section 640 of the report, including foundations, floors, frames, exterior walls, openings, finish, stone, masonry, accents, panel siding, windows, doors, windows, interior and exterior doors, roof, soffit, interior finish, floor finish, bathrooms, plumbing, electrical, kitchen items. Hardware/wiring/outlets for cable, TV, phone, and internet may be included in the electronics analysis.

Cost analyses are also identified in the report of FIGS. 6A and 6B and 6C, including direct cost items 650, indirect cost items 660, and a grand total 670. The direct cost items 650 include excavation, foundation, city permits, local permits, piers, flatwork, insulation, rough hardware, framing, exterior finish, exterior trip, doors, windows, roofing, soffit, fascia, finish carpentry, interior wall finish, lighting fixtures, painting, carpet, flooring, bath accessories, shower and tub accessories, plumbing fixtures, plumbing rough-in, wiring, built-in appliances, cabinets, countertops, central heating, central cooling, fire or other sprinklers, garage door, fireplace.

FIG. 6C illustrates a third portion of a report generated based on the captured media and generated layout.

The indirect cost items 660 include final cleanup, insurance permits, utilities, design, and engineering. The grand total 670 also includes contractor markup.

The technologies described herein can be used to prepare reports such as the one in FIGS. 6A and 6B and 6C in that media data captured by UAVs 105 and other sensors can be compared—at the capture devices or at servers 525—to reference images in databases, which can allow items to be recognized, such as compare items—such as brands of appliances, or types of wood used for cabinets or floors, or types of carpeting or walls or doors, and the like.

The virtual remote site collected data is transmitted to and received into the cloud, is real-time, dynamic information and can be processed to provide real-time responses, predictive analyses, (FNOL) First Notice of Loss, integrated media and maps, integrated with other third party data to fulfill any needed property claim or appraisal request type, integrated maps and certified media into reports, preliminary reports, scope of situation with evidentiary certified media, estimates, tracking, payments, solutions and answers.

The detailed property claim or appraisal system can also include an estimation of loss of property to be used to document values of property. It also can be used for possessions or equipment to be included as part of a property claim or appraisal which can easily be accomplished by capturing certified media of a specific items. Then utilizing web interfaces or internal/external integral databases such for example the Craftsman's National Construction Estimator (NCE) publication cost book to look up the item intelligently either manually or in automated function. By using media, mobile digital devices, one can build an entire claim or adjuster file into a single file. All Claim estimates, valuations, certified media, reports, pre-fill forms, diagrams, and other electronic attachments make creating a total electronic estimating package convenient and efficient. An additional element of the patent is to automatically upload a prior historical appraisal which captures the data and holds in a record in case of a catastrophic event that may destroy the home. This way, the reconstruction will be based upon the original appraisal information which will save money for the insurance company by having access to the data.

The database or web interface or digital device can first identify the damage or items directly in the media using (AI) artificial intelligence and search database or web to find an identical or similar item and price it accordingly in the claim or appraisal estimate valuation system database. The system has standard reference items that can be selected to compare the item or equipment. For example, furnaces, air conditioners, swimming pool motors, spa heaters for exterior, and interior items such as microwaves, refrigerators, TV's, Computers, smartphones, printers, lumber, wallboard, carpeting, flooring, plumbing, electrical wiring, while also adding time and materials for restoration, labor and all construction materials for repair of damaged property.

FIG. 7A illustrates an unmanned aerial vehicle (UAV).

UAV 105 can have one or more motors 750 configured to rotate attached propellers 755 in order to control the position of UAV 105 in the air. UAV 105 can be configured as a fixed wing vehicle (e.g., airplane), a rotary vehicle (e.g., a helicopter or multirotor), or a blend of the two.

For the purpose of FIG. 7A, axes 775 can assist in the description of certain features and their relative orientations. If UAV 105 is oriented parallel to the ground, the Z axis can be the axis perpendicular to the ground, the X axis can generally be the axis that passes through the bow and stern of UAV 105, and the Y axis can be the axis that pass through the port and starboard sides of UAV 105. Axes 775 are merely provided for convenience of the description herein.

In some embodiments, UAV 105 has main body 710 with one or more arms 740. The proximal end of arm 740 can attach to main body 710 while the distal end of arm 740 can secure motor 750. Arms 740 can be secured to main body 710 in an “X” configuration, an “H” configuration, a “T” configuration, a “Y” configuration, or any other configuration as appropriate. The number of motors 750 can vary, for example there can be three motors 750 (e.g., a “tricopter”), four motors 750 (e.g., a “quadcopter”), eight motors (e.g., an “octocopter”), etc.

In some embodiments, each motor 755 rotates (i.e., the drive shaft of motor 755 spins) about parallel axes. For example, the thrust provided by all propellers 755 can be in the Z direction. Alternatively, a motor 755 can rotate about an axis that is perpendicular (or any angle that is not parallel) to the axis of rotation of another motor 755. For example, two motors 755 can be oriented to provide thrust in the Z direction (e.g., to be used in takeoff and landing) while two motors 755 can be oriented to provide thrust in the X direction (e.g., for normal flight). In some embodiments, UAV 105 can dynamically adjust the orientation of one or more of its motors 750 for vectored thrust.

In some embodiments, the rotation of motors 750 can be configured to create or minimize gyroscopic forces. For example, if there are an even number of motors 750, then half of the motors can be configured to rotate counter-clockwise while the other half can be configured to rotate clockwise. Alternating the placement of clockwise and counter-clockwise motors can increase stability and enable UAV 105 to rotate about the z-axis by providing more power to one set of motors 750 (e.g., those that rotate clockwise) while providing less power to the remaining motors (e.g., those that rotate counter-clockwise).

Motors 750 can be any combination of electric motors, internal combustion engines, turbines, rockets, etc. In some embodiments, a single motor 750 can drive multiple thrust components (e.g., propellers 755) on different parts of UAV 105 using chains, cables, gear assemblies, hydraulics, tubing (e.g., to guide an exhaust stream used for thrust), etc. to transfer the power.

In some embodiments, motor 750 is a brushless motor and can be connected to electronic speed controller X45. Electronic speed controller 745 can determine the orientation of magnets attached to a drive shaft within motor 750 and, based on the orientation, power electromagnets within motor 750. For example, electronic speed controller 745 can have three wires connected to motor 750, and electronic speed controller 745 can provide three phases of power to the electromagnets to spin the drive shaft in motor 750. Electronic speed controller 745 can determine the orientation of the drive shaft based on back-end on the wires or by directly sensing to position of the drive shaft.

Transceiver 765 can receive control signals from a control unit (e.g., a handheld control transmitter, a server, etc.). Transceiver 765 can receive the control signals directly from a control unit 800 or through a network (e.g., a satellite, cellular, mesh, etc.). The control signals can be encrypted. In some embodiments, the control signals include multiple channels of data (e.g., “pitch,” “yaw,” “roll,” “throttle,” and auxiliary channels). The channels can be encoded using pulse-width-modulation or can be digital signals. In some embodiments, the control signals are received over TC/IP or similar networking stack.

In some embodiments, transceiver 765 can also transmit data to a control unit 800. Transceiver 765 can communicate with the control unit using lasers, light, ultrasonic, infra-red, Bluetooth, 802.11x, or similar communication methods, including a combination of methods. Transceiver can communicate with multiple control units 800 at a time. The transceiver 765 can also be used to send media data captured by the camera 705 and/or other sensors of the UAV 105 to a secondary device, such as a server 525 or client 530, either before or after media certification 510.

Position sensor 735 can include an inertial measurement unit (IMU) or inertial navigation system (INS) for determining the acceleration and/or the angular rate of UAV 105 using one or more accelerometers and/or gyroscopes, a GPS receiver for determining the geolocation and altitude of UAV 105, a magnetometer for determining the surrounding magnetic fields of UAV 105 (for informing the heading and orientation of UAV 105), a barometer for determining the altitude of UAV 105, etc. Position sensor 735 can include a land-speed sensor, an air-speed sensor, a celestial navigation sensor, etc.

UAV 105 can have one or more environmental awareness sensors. These sensors can use sonar, SODAR or SODAR transmitters or receivers or transceivers, LiDAR transmitters or receivers or transceivers, stereoscopic imaging, a synthetic aperture radar (SAR) transmitters or receivers or transceivers, and ground penetrating radar (GPR) transmitters or receivers or transceivers, to determine items located underground and creating a target location and position, cameras paired with computer vision algorithms executed by a processor, and combinations thereof, both to capture media to determine and analyze the nearby environment (e.g., property 110) and to detect and avoid obstacles. For example, a collision and obstacle avoidance system can use environmental awareness sensors to determine how far away an obstacle is and, if necessary, change course.

Position sensor 735 and environmental awareness sensors can all be one unit or a collection of units. In some embodiments, some features of position sensor 735 and/or the environmental awareness sensors are embedded within flight controller 730.

In some embodiments, an environmental awareness system can take inputs from position sensors 735, environmental awareness sensors, databases (e.g., a predefined mapping of a region) to determine the location of UAV 105, obstacles, and pathways. In some embodiments, this environmental awareness system is located entirely on UAV 105, alternatively, some data processing can be performed external to UAV 105.

Camera 705 can include an image sensor (e.g., a CCD sensor, a CMOS sensor, etc.), a lens system, a processor, etc. The lens system can include multiple movable lenses that can be adjusted to manipulate the focal length and/or field of view (i.e., zoom) of the lens system. In some embodiments, camera 705 is part of a camera system which includes multiple cameras 705. For example, two cameras 705 can be used for stereoscopic imaging (e.g., for first person video, augmented reality, etc.). Another example includes one camera 705 that is optimized for detecting hue and saturation information and a second camera 705 that is optimized for detecting intensity information. In some embodiments, camera 705 optimized for low latency is used for control systems while a camera 705 optimized for quality is used for recording a video (e.g., a cinematic video). Camera 705 can be a visual light camera, an infrared camera, a depth camera, etc.

A gimbal and dampeners can help stabilize camera 705 and remove erratic rotations and translations of UAV 105. For example, a three-axis gimbal can have three stepper motors that are positioned based on a gyroscope reading in order to prevent erratic spinning and/or keep camera 705 level with the ground. Alternatively, image stabilization can be performed digitally using a combination of motion flow vectors from image processing and data from inertial sensors such as accelerometers and gyros.

Video processor 725 can process a video signal from camera 705. For example video process 725 can enhance the image of the video signal, down-sample or up-sample the resolution of the video signal, add audio (captured by a microphone) to the video signal, overlay information (e.g., flight data from flight controller 730 and/or position sensor), convert the signal between forms or formats, etc.

Video transmitter 720 can receive a video signal from video processor 725 and transmit it using an attached antenna. The antenna can be a cloverleaf antenna or a linear antenna. In some embodiments, video transmitter 720 uses a different frequency or band than transceiver 765. In some embodiments, video transmitter 720 and transceiver 765 are part of a single transceiver. The video transmitter 720 can also send media data captured from any other sensor of the UAV 105, before or after media certification 510. The video transmitter 720 can optionally be merged into the transceiver 765.

Battery 770 can supply power to the components of UAV 105. A battery elimination circuit can convert the voltage from battery 770 to a desired voltage (e.g., convert 12v from battery 770 to 5v for flight controller 730). A battery elimination circuit can also filter the power in order to minimize noise in the power lines (e.g., to prevent interference in transceiver 765 and transceiver 720). Electronic speed controller 745 can contain a battery elimination circuit. For example, battery 770 can supply 12 volts to electronic speed controller 745 which can then provide 5 volts to flight controller 730. In some embodiments, a power distribution board can allow each electronic speed controller (and other devices) to connect directly to the battery.

In some embodiments, battery 770 is a multi-cell (e.g., 2S, 3S, 4S, etc.) lithium polymer battery. Battery 770 can also be a lithium-ion, lead-acid, nickel-cadmium, or alkaline battery. Other battery types and variants can be used as known in the art. Additional or alternative to battery 770, other energy sources can be used. For example, UAV 105 can use solar panels, wireless or inductive power transfer, a tethered power cable (e.g., from a ground station or another UAV 105), etc. In some embodiments, the other energy source can be utilized to charge battery 770 while in flight or on the ground.

Battery 770 can be securely mounted to main body 710. Alternatively, battery 770 can have a release mechanism. In some embodiments, battery 770 can be automatically replaced. For example, UAV 105 can land on a docking station and the docking station can automatically remove a discharged battery 770 and insert a charged battery 770. In some embodiments, UAV 105 can pass through a docking station and replace battery 770 without stopping.

Battery 770 can include a temperature sensor for overload prevention. For example, when charging, the rate of charge can be thermally limited (the rate will decrease if the temperature exceeds a certain threshold). Similarly, the power delivery at electronic speed controllers 745 can be thermally limited—providing less power when the temperature exceeds a certain threshold. Battery 770 can include a charging and voltage protection circuit to safely charge battery 770 and prevent its voltage from going above or below a certain range.

UAV 105 can include a location transponder. For example, in a property surveying environment, a property surveyor can track the UAV 105's position about the property using location transponder including ADS-B in and out. The actual location (e.g., X, Y, and Z) can be tracked using triangulation of the transponder. In some embodiments, gates or sensors in a track can determine if the location transponder has passed by or through the sensor or gate.

Flight controller 730 can communicate with electronic speed controller 745, battery 770, transceiver 765, video processor 725, position sensor 735, and/or any other component of UAV 105. In some embodiments, flight controller 730 can receive various inputs (including historical data) and calculate current flight characteristics. Flight characteristics can include an actual or predicted position, orientation, velocity, angular momentum, acceleration, battery capacity, temperature, etc. of UAV 105. Flight controller 730 can then take the control signals from transceiver 765 and calculate target flight characteristics. For example, target flight characteristics might include “rotate x degrees” or “go to this GPS location”. Flight controller 730 can calculate response characteristics of UAV 105. Response characteristics can include how electronic speed controller 745, motor 750, propeller 755, etc. respond, or are expected to respond, to control signals from flight controller 730. Response characteristics can include an expectation for how UAV 105 as a system will respond to control signals from flight controller 730. For example, response characteristics can include a determination that one motor 750 is slightly weaker than other motors.

After calculating current flight characteristics, target flight characteristics, and response characteristics flight controller 730 can calculate optimized control signals to achieve the target flight characteristics. Various control systems can be implemented during these calculations. For example a proportional-integral-derivative (PID) can be used. In some embodiments, an open-loop control system (i.e., one that ignores current flight characteristics) can be used. In some embodiments, some of the functions of flight controller 730 are performed by a system external to UAV 105. For example, current flight characteristics can be sent to a server that returns the optimized control signals. Flight controller 730 can send the optimized control signals to electronic speed controllers 745 to control UAV 105.

In some embodiments, UAV 105 has various outputs that are not part of the flight control system. For example, UAV 105 can have a loudspeaker for communicating with people or other UAVs 105. Similarly, UAV 105 can have a flashlight or laser. The laser can be used to “tag” another UAV 105.

The UAV 105 may have many sensors, such as the camera 705, for producing visual data, including video cameras and still image cameras that operate in the visual spectrum and/or other electromagnetic spectra, such as infrared, ultraviolet, radio, microwave, x-ray, or any subset or combination thereof. The UAV 105 may have positioning sensors, including one or more Global Navigation Satellite System (GNSS) receivers such as Global Positioning System (GPS) receivers, Glonass receivers, Beidou receivers, and Galileo receivers, optionally with real time kinematics (RTK) differential GNSS corrections such as Radio Technical Commission for Maritime Services (RTCM) or Compact Measurement Record (CMR).

FIG. 7B illustrates an unmanned ground vehicle (UGV).

The UGV 180 of FIG. 7B can include any of the components identified with respect to the UAV 105 of FIG. 7A, including but not limited to the camera 705, transceiver 765, video transmitter 720, RADAR transceivers, LiDAR or EmDAR transceivers, SONAR or SODAR transceivers, laser rangefinders, GPR transceivers, SAR transceivers, or combinations thereof. The UGV 180 also includes one or more wheels 780, which the UGV 180 actuates with electric or gasoline-powered motors to guide the UGV 180 along a path or route. The UGV 180 may have any combination of any of the sensors discussed with regard to FIG. 7A with respect to the UAV 105.

While FIG. 7A and FIG. 7B illustrate a UAV 105 and UGV 180 respectively, it should be understood that any USVs and UUVs used for property analysis may include the same types of sensors and other hardware discussed with respect to the UAV 105 and UGV 180.

FIG. 8 illustrates a control device for an unmanned vehicle.

Control transmitter 800 can send control signals to transceiver 765. Control transmitter can have auxiliary switches 810, joysticks 815 and 820, and antenna 805. Joystick 815 can be configured to send elevator and aileron control signals while joystick 820 can be configured to send throttle and rudder control signals (this is termed a mode 2 configuration). Alternatively, joystick 815 can be configured to send throttle and aileron control signals while joystick 820 can be configured to send elevator and rudder control signals (this is termed a mode 1 configuration). Auxiliary switches 810 can be configured to set options on control transmitter 800 or UAV 105. In some embodiments, control transmitter 800 receives information from a transceiver on UAV 105 or UGV 180. For example, it can receive captured media or some current flight or drive characteristics from UAV 105 or UGV 180. Control transmitter can also use an autopilot function to fly a previously prepared flight plan including sensor target details to collection and automatically return to a predetermined or adjusted location on completion.

FIG. 9 illustrates a head-mounted display for viewing media captured by an unmanned vehicle or other media capture device.

Display 900 can include battery 905 or another power source, display screen 910, and receiver 915. Display 900 can receive a video stream from transmitter 720 from UAV 100. Display 900 can be a head-mounted unit as depicted in FIG. 9. Display 900 can be a monitor such that multiple viewers can view a single screen. In some embodiments, display screen 910 includes two screens, one for each eye; these screens can have separate signals for stereoscopic viewing. In some embodiments, receiver 915 is mounted on display 900 (as shown in FIG. 9), alternatively, receiver 915 can be a separate unit that is connected using a wire to display 900. The display 900 may be used, for example, for a virtual reality walkthrough of the generated layout 190/290/390, or an augmented reality walkthrough of a property 110 or structure 120/220/320 during which media collected—or portions of the generated layout 190/290/390—may pop up on the display 900 at appropriate locations, such as those latitude and longitude coordinates—and heading/direction/inclinations/altitudes—marked with reference images in the generated layouts 190/290/390. In some embodiments, display 900 is mounted on control transmitter 800.

FIG. 10 illustrates security certification of digital media for verification of authenticity. The media security certification of FIG. 10 may be performed by media capture device (of steps 505/510) and/or by the 525.

At step 1010, media is captured by a media capture device, which may be a mobile device as illustrated in FIG. 10, a UAV 105 or UGV 180 or USV or UUV as discussed above, or any other device discussed herein. At step 1020, the captured media and its corresponding metadata are gathered and converted to an appropriate format if necessary, the metadata including, for example, latitude and longitude coordinates from a GNSS receiver or other positioning receiver, an identification of the media capture device, a timestamp identifying date and time and optionally time zone of capture, an altitude at capture, a heading at capture, an inclination at capture, a yaw at capture, a roll at capture, a watermark, any other data that might be found in image EXIF metadata, or combinations thereof. In some cases, the media at steps 1010 and 1020 may also include media that has been generated, such as a generated layout like the generated layout 190 of FIG. 1B, the generated layout 290 of FIG. 2B, or the generated layout 390 of FIG. 3B.

At step 1030, an asymmetric public key infrastructure (PKI) key pair—with a private key and a corresponding public key—are generated, either by the media capture device of step 1010 or by server 525. These may be RSA 1024 asymmetric keys.

At step 1040, a digital signature is computed by generating a hash digest—optionally using a secure hash algorithm such as SHA-0, SHA-1, SHA-2, or SHA-3—of the captured media, and optionally of the metadata as well. At step 1050, the digital signature is encrypted with the private key. The media asset and the metadata may also optionally be encrypted via the private key. The private key is optionally destroyed. At step 1060, the captured media—either encrypted or not—is transferred to the servers 525 along with the encrypted digital signature and the metadata, which may also be either encrypted or not. The public key may also be transferred to the servers 525 along with these, or they may be published elsewhere.

In some embodiments, these data integrity precautions can include securing all non-asset data can in a local database with a globally unique identifier to ensure its integrity. The asset's security and integrity can be ensured via a Digital Signature that is made up of a SHA-1 digest, the time that the asset was captured and the device of origin. This allows the mobile app or server to detect changes due to storage or transmission errors as well as any attempt to manipulate or change the content of the asset. The digital signature can be encrypted with a private key of a public/private key-pair that was generated uniquely for that asset. The media and/or metadata may also be encrypted using the private key. The private key can be destroyed and/or never written to disk or stored in memory; as such, this ensures that the asset cannot be re-signed or changed in a way that cannot be tracked. The public key can be published and made accessable to anyone wishing to verify authenticity of the media by decrypting the media and/or metadata and/or digital signature.

FIG. 11 is a flow diagram illustrating an exemplary method for security certification and verification of digital media.

At step 1105, media is captured by a media capture device, optionally with its metadata as well. The metadata may include, for example, latitude and longitude coordinates from a GNSS receiver or other positioning receiver, an identification of the media capture device, a timestamp identifying date and time of capture, an altitude at capture, a heading at capture, an inclination at capture, a yaw at capture, a roll at capture, a watermark, any other data that might be found in image EXIF metadata, or combinations thereof. In some cases, the media at step 1105 may also include media that has been generated, such as a generated layout like the generated layout 190 of FIG. 1B, the generated layout 290 of FIG. 2B, or the generated layout 390 of FIG. 3B.

At step 1110, an asymmetric public key infrastructure (PKI) key pair—with a private key and a corresponding public key—is generated by the media capture device of step 1105 or by server 525. These may be RSA 1024 asymmetric keys.

At step 1115, a digital signature is computed by generating a hash digest—optionally using a secure hash algorithm such as SHA-0, SHA-1, SHA-2, or SHA-3—of the captured media, and optionally of the metadata as well. At step 1120, the digital signature is encrypted with the private key. The media and/or metadata may also be encrypted using the private key. The private key is optionally destroyed at step 1125, or may be never be written to non-volatile memory in the first place.

At step 1130, the public key is published, either by sending it to the servers 525, to an authentication server such as a certificate authority, or by otherwise sending it for publication in another publically accessible and trusted network location. At step 1135, verification as to the authenticity of the media and metadata may occur by decrypting the encrypted digital signature using the public key before or after publication at step 1130, and verifying whether or not the hash digest stored as part of the decrypted digital signature matches a newly generated hash digest of the media. The same can be done using the metadata if a hash digest of the metadata is included in the digital signature. The verification as to the authenticity of the media and metadata at step 1135 may also include decrypting the media asset and/or the metadata itself, if either or both were encrypted at step 1120. This verification may occur at the digital media capture device—though it may instead or additionally be performed at the server 525, for example before the server 525 indexes the media as part of a cloud storage system accessible by client devices 530.

Assuming the authentication of step 1135 was successful, a certified media dataset is generated by bundling the media, metadata, and the encrypted digital signature, for example in a zip file or other compressed archive file. The public key may also be bundled with them, though additional security may be provided by publishing it elsewhere to a trusted authentication server. At step 1145, the certified media dataset (and optionally the public key) is transmitted to a secondary device, such as a server 525 or a viewer device (i.e., a client device 530).

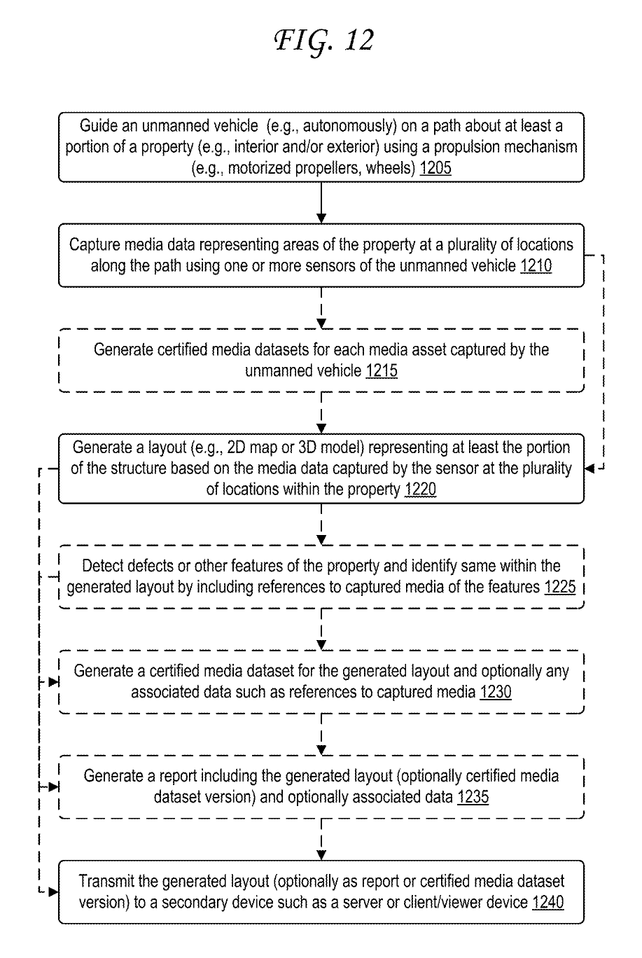

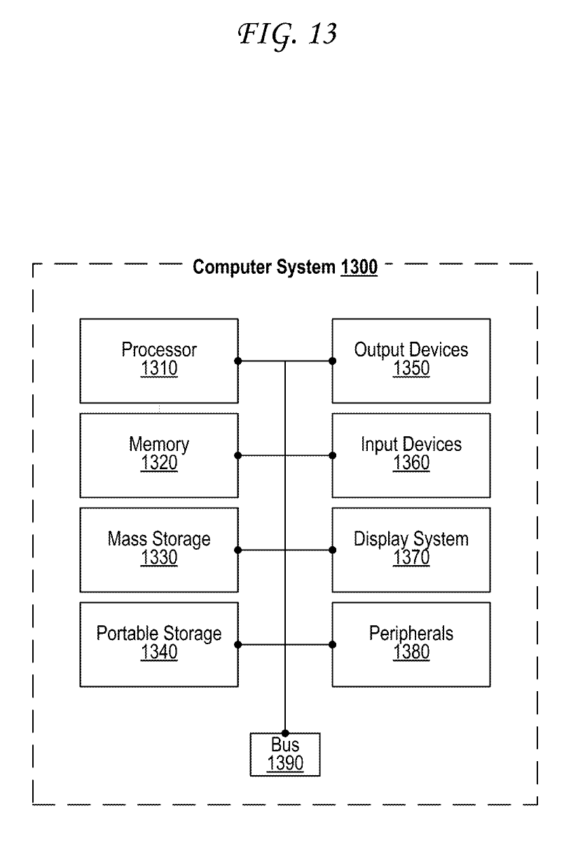

FIG. 12 is a flow diagram illustrating an exemplary method for property analysis and layout generation.

Step 1205 involves guiding an unmanned vehicle on a path about at least a portion of a property using a propulsion mechanism. Guidance may be remotely, autonomously, semi-autonomously, or some combination thereof. The portion of the property may include any portion of the property 110 that is labeled in FIG. 1A or any sub-portion thereof, such as at least a portion of the of surface 150, at least a portion of the underground 155, at least a portion of an exterior 130 of a structure 120 on the surface 150, at least a portion of an interior 135 of the structure, at least a portion of the roof 140 of the structure 120, at least a portion of the airspace 145 above the surface 150, at least a portion of the surface of any body of water present on the property (not shown in FIG. 1A), at least a portion of the underwater volume of any body of water present on the property (not shown in FIG. 1A), or a combination thereof. The unmanned vehicle may be a UAV 105, a UGV 180, a USV, a UUV, or some combination thereof. The propulsion mechanism may include one or more electric or gasoline motors actuating propellers, wheels, legs, treads, or combinations thereof.

Step 1210 involves capturing media data representing areas of the property at a plurality of locations along the path using one or more sensors of the unmanned vehicle 1210. These sensors may include cameras, SONAR, SODAR, LIDAR, laser rangefinders, or any other sensors discussed herein.

Optional step 1215 involves generating certified media datasets for each media asset captured by the unmanned vehicle 1215. This process is outlined in FIG. 10, FIG. 11, and the corresponding descriptions.

Step 1220 involves generating a layout representing at least the portion of the structure based on the media data captured by the sensor at the plurality of locations within the property. The generated layout may be a 2-dimensional map, optionally with topography data, and multiple floors of a structure depicted separately, or may be a 3-dimensional model such as a computer-aided design (CAD) or computer-aided design and drafting (CADD) model.

Optional step 1225 involves detecting defects or other issues with the property and identifying these within the generated layout, optionally including references to captured media as in the reference images, reference videos, and reference data of FIG. 1B, FIG. 2B, or FIG. 3B. These may be detected using techniques such as edge detection, image detection, or feature detection, and may involve comparing the media assets to reference images of known defects or images stored in a data structure such as a database along with the identification of the defect or issue they depict. For example, an image of a bathroom wall captured by the UAV 105 may be compared to images in a reference database and can be identified based on feature recognition to be 80% similar to a reference image previously classified as depicting water damage, and based on this similarity level exceeding a predefined similarity threshold (for example 70%), the UAV 105 or server 525 decides that the image of the bathroom wall captured by the UAV 105 also shows water damage. In another example, edge detection can detect a cluster of edges together in and can determine this appears to look like a cracked glass simply due to the number of edges or also based on comparison to reference images of cracked glass.

Optional step 1230 involves generating a certified media dataset for the generated layout and optionally any associated data such as references to captured media. This process is outlined in FIG. 10, FIG. 11, and the corresponding descriptions.

Optional step 1235 involves generating a report including or based on the generated layout and optionally including associated data such as the reference images, reference videos, and reference data of FIG. 1B, FIG. 2B, or FIG. 3B. This report may be an estimate report or property analysis report with claim and/or repair and/or appraisal data such as the report identified in FIG. 6A and FIG. 6B and FIG. 6C. This report may include any data illustrated in and/or discussed with respect to FIG. 1B, FIG. 2B, or FIG. 3B, or any other media, sensor data, or other data captured or measured using any sensor or data collection hardware, software, or combination thereof discussed herein.

Step 1240 involves transmitting at least the generated layout to a secondary device such as a server 525 or client/viewer device 530. If a certified media dataset version of the generated layout was generated at step 1230, this certified media dataset version may be what is sent at step 1240. If a report using the generated layout was generated at step 1235, this report may be what is sent at step 1240. Associated data, such as the reference images, reference videos, and reference data of FIG. 1B, FIG. 2B, or FIG. 3B, may also be sent to the secondary device.

FIG. 13 is a block diagram of an exemplary computing device that may be used to implement some aspects of the technology. FIG. 13 illustrates an exemplary computing system 1300 that may be used to implement some aspects of the technology. For example, any of the computing devices, computing systems, network devices, network systems, servers, and/or arrangements of circuitry described herein may include at least one computing system 1300, or may include at least one component of the computer system 1300 identified in FIG. 13. The computing system 1300 of FIG. 13 includes one or more processors 1310 and memory 1320. Each of the processor(s) 1310 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 1310 may include one or more cores, either integrated onto a single chip or spread across multiple chips connected or coupled together. Memory 1320 stores, in part, instructions and data for execution by processor 1310. Memory 1320 can store the executable code when in operation. The system 1300 of FIG. 13 further includes a mass storage device 1330, portable storage medium drive(s) 1340, output devices 1350, user input devices 1360, a graphics display 1370, and peripheral devices 1380.

The components shown in FIG. 13 are depicted as being connected via a single bus 1390. However, the components may be connected through one or more data transport means. For example, processor unit 1310 and memory 1320 may be connected via a local microprocessor bus, and the mass storage device 1330, peripheral device(s) 1380, portable storage device 1340, and display system 1370 may be connected via one or more input/output (I/O) buses.

Mass storage device 1330, which may be implemented with a magnetic disk drive or an optical disk drive, is a non-volatile storage device for storing data and instructions for use by processor unit 1310. Mass storage device 1330 can store the system software for implementing some aspects of the subject technology for purposes of loading that software into memory 1320.

Portable storage device 1340 operates in conjunction with a portable non-volatile storage medium, such as a floppy disk, compact disk or Digital video disc, to input and output data and code to and from the computer system 1300 of FIG. 13. The system software for implementing aspects of the subject technology may be stored on such a portable medium and input to the computer system 1300 via the portable storage device 1340.

The memory 1320, mass storage device 1330, or portable storage 1340 may in some cases store sensitive information, such as transaction information, health information, or cryptographic keys, and may in some cases encrypt or decrypt such information with the aid of the processor 1310. The memory 1320, mass storage device 1330, or portable storage 1340 may in some cases store, at least in part, instructions, executable code, or other data for execution or processing by the processor 1310.

Output devices 1350 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 1370. The printer may be inkjet, laserjet, thermal, or some combination thereof. In some cases, the output device circuitry 1350 may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, 802.11 Wi-Fi wireless signal transfer, cellular data network wireless signal transfer, a radio wave signal transfer, a microwave signal transfer, an infrared signal transfer, a visible light signal transfer, an ultraviolet signal transfer, a wireless signal transfer along the electromagnetic spectrum, or some combination thereof. Output devices 1350 may include any ports, plugs, antennae, wired or wireless transmitters, wired or wireless transceivers, or any other components necessary for or usable to implement the communication types listed above, such as cellular Subscriber Identity Module (SIM) cards.

Input devices 1360 may include circuitry providing a portion of a user interface. Input devices 1360 may include an alpha-numeric keypad, such as a keyboard, for inputting alpha-numeric and other information, or a pointing device, such as a mouse, a trackball, stylus, or cursor direction keys. Input devices 1360 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, 802.11 Wi-Fi wireless signal transfer, wireless local area network (WAN) signal transfer, cellular data network wireless signal transfer, personal area network (PAN) signal transfer, wide area network (WAN) signal transfer, a radio wave signal transfer, a microwave signal transfer, an infrared signal transfer, a visible light signal transfer, an ultraviolet signal transfer, a wireless signal transfer along the electromagnetic spectrum, or some combination thereof. Input devices 1360 may include any ports, plugs, antennae, wired or wireless receivers, wired or wireless transceivers, or any other components necessary for or usable to implement the communication types listed above, such as cellular SIM cards.

Input devices 1360 may include receivers or transceivers used for positioning of the computing system 1300 as well. These may include any of the wired or wireless signal receivers or transceivers. For example, a location of the computing system 1300 can be determined based on signal strength of signals as received at the computing system 1300 from three cellular network towers, a process known as cellular triangulation. Fewer than three cellular network towers can also be used—even one can be used—though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 1300 such as a router, modem, switch, hub, bridge, gateway, or repeater. These may also include Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 1360 may include receivers or transceivers corresponding to one or more of these GNSS systems.

Display system 1370 may include a liquid crystal display (LCD), a plasma display, an organic light-emitting diode (OLED) display, an electronic ink or “e-paper” display, a projector-based display, a holographic display, or another suitable display device. Display system 1370 receives textual and graphical information, and processes the information for output to the display device. The display system 1370 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1380 may include any type of computer support device to add additional functionality to the computer system. For example, peripheral device(s) 1380 may include one or more additional output devices of any of the types discussed with respect to output device 1350, one or more additional input devices of any of the types discussed with respect to input device 1360, one or more additional display systems of any of the types discussed with respect to display system 1370, one or more memories or mass storage devices or portable storage devices of any of the types discussed with respect to memory 1320 or mass storage 1330 or portable storage 1340, a modem, a router, an antenna, a wired or wireless transceiver, a printer, a bar code scanner, a quick-response (“QR”) code scanner, a magnetic stripe card reader, an integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a LIDAR transceiver, a network device, a motor, an actuator, a pump, a conveyer belt, a robotic arm, a rotor, a drill, a chemical assay device, or some combination thereof.

The components contained in the computer system 1300 of FIG. 13 can include those typically found in computer systems that may be suitable for use with some aspects of the subject technology and represent a broad category of such computer components that are well known in the art. That said, the computer system 1300 of FIG. 13 can be customized and specialized for the purposes discussed herein and to carry out the various operations discussed herein, with specialized hardware components, specialized arrangements of hardware components, and/or specialized software. Thus, the computer system 1300 of FIG. 13 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 1300 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNU®, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 1300 may also use a Basic Input/Output System (BIOS) or Unified Extensible Firmware Interface (UEFI) as a layer upon which the operating system(s) are run.

In some cases, the computer system 1300 may be part of a multi-computer system that uses multiple computer systems 1300, each for one or more specific tasks or purposes. For example, the multi-computer system may include multiple computer systems 1300 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 1300 from different networks communicatively coupled together via the Internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 1320, the mass storage 1330, the portable storage 1340, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L13), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 1310 for execution. A bus 1390 carries the data to system RAM or another memory 1320, from which a processor 1310 retrieves and executes the instructions. The instructions received by system RAM or another memory 1320 can optionally be stored on a fixed disk (mass storage device 1330/portable storage 1340) either before or after execution by processor 1310. Various forms of storage may likewise be implemented as well as the necessary network interfaces and network topologies to implement the same.

While various flow diagrams provided and described above—including at least those of FIG. 10, FIG. 11, and FIG. 12—may show a particular order of operations performed by some embodiments of the subject technology, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 1300 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated.

What is claimed is:

1. A property analysis system comprising:
an unmanned vehicle that moves within a property and captures media data representing areas within the property;
a memory that stores instructions;
a processor that executes the stored instructions, wherein execution of the stored instructions by the processor causes the processor to:
guide movement of the unmanned vehicle to a plurality of locations within the property, wherein the movement of the unmanned vehicle is guided on a first path along an exterior of a structure on the property and on a second path along an interior of the structure,
analyze the captured media data to identify at least one feature of the structure at an identified one of the plurality of locations within the property, and
generate a layout representing at least a portion of the structure based on the analyzed media data, wherein the generated layout includes the identified feature mapped to the identified location within the property; and
a communication transceiver that transmits the layout to a secondary device.

2. The property analysis system of claim 1, wherein the first path is continuous, and wherein the second path is continuous.

3. The property analysis system of claim 1, wherein at least one of the first path or the second path is not continuous.

4. A property analysis system comprising:
a propulsion mechanism that moves an unmanned vehicle about a property;
a sensor of the unmanned vehicle that captures media data representing areas of the property at a plurality of locations within the property;
a memory that stores instructions;
a processor that executes the stored instructions, wherein execution of the stored instructions by the processor causes the processor to:
guide movement of the unmanned vehicle on a path about at least a portion of a structure on the property using the propulsion mechanism, wherein at least a subset of the plurality of locations within the property are along the path,
analyze the captured media data to identify a feature of the property at an identified one of the plurality of locations within the property, and
generate a layout representing at least the portion of the structure based on the media data captured by the sensor at the plurality of locations within the property, wherein the layout includes the feature mapped to a location within the layout that corresponds to the identified one of the plurality of locations within the property; and
a communication transceiver that transmits the layout to a secondary device.

5. The property analysis system of claim 4, wherein the path is directed about at least a portion of an exterior of the structure, and wherein the portion of the structure represented by the layout includes at least a portion of the exterior.

6. The property analysis system of claim 4, wherein the path is directed about at least a portion of an interior of the structure, and wherein the portion of the structure represented by the layout includes at least a portion of the interior.

7. The property analysis system of claim 4, wherein the layout is a three-dimensional model, and wherein generating the layout is based on three-dimensional modeling based on the media data captured by the sensor at the plurality of locations within the property.

8. The property analysis system of claim 4, wherein execution of further instructions by the processor causes the processor to generate an estimate of a distance from a first point within the property to a second point within the property based on a corresponding distance from a corresponding first point within the layout to a corresponding second point within the layout.

9. The property analysis system of claim 4, wherein the sensor includes a camera, and wherein the media data includes at least one visual media asset captured by the camera.

10. The property analysis system of claim 4, wherein the sensor includes a range sensor that measures distance from the range sensor by detecting a reflection of electromagnetic radiation, and wherein the media data includes at least one distance measurement captured using the range sensor.

11. The property analysis system of claim 4, wherein the sensor includes a range sensor that measures distance from the range sensor by detecting a reflection of sound, and wherein the media data includes at least one distance measurement captured using the range sensor.

12. The property analysis system of claim 4, wherein the sensor includes a Global Navigation Satellite System (GNSS) receiver, and wherein the media data includes at least one location captured using the GNSS receiver.

13. The property analysis system of claim 4, wherein the sensor includes an Inertial Measurement Unit (IMU), and wherein the media data includes at least one inertial measurement captured using the IMU.

14. The property analysis system of claim 4, wherein generating the layout comprises applying a space mapping algorithm.

15. The property analysis system of claim 4, wherein execution of further instructions by the processor causes the processor to:
identify that one of the areas of the property has undergone flood damage based on detecting that the captured media data representing the identified area includes an irregularity characteristic of flood damage, and
identify a location within the layout corresponding to the identified area of the property that has undergone flood damage.

16. The property analysis system of claim 4, wherein generating the layout comprises generating a plurality of layout portions based on portions of the media data that are captured as the unmanned vehicle is guided along the path.

17. The property analysis system of claim 4, wherein the generated layout further includes a reference to an image from the media data captured by a camera of the sensor, wherein the layout further maps the referenced image to one of the locations within the property.

18. The property analysis system of claim 4, wherein execution of further instructions by the processor causes the processor to generate a report based on the layout, wherein the communication transceiver transmits the layout to the secondary device by transmitting the report to the secondary device.

19. The property analysis system of claim 4, wherein execution of further instructions by the processor causes the processor to:
generate a unique key pair comprising a private key and a public key,
generate a hash digest of at least one media asset of the media data,
generate an encrypted digital signature by encrypting at least the hash digest using the private key, and
verify that the at least one media asset is genuine by decrypting the encrypted digital signature using the public key to retrieve the hash digest and by verifying that the hash digest corresponds to a newly generated hash digest of the at least one media asset.

20. A method of property analysis, the method comprising:
guiding movement of an unmanned vehicle along a path about at least a portion of a property using a propulsion mechanism of the unmanned vehicle;
capturing media data using a sensor of the unmanned vehicle, the media data representing areas of the property at a plurality of locations along the path;
analyze the media data to identify a feature of the property at an identified one of the plurality of locations within the property;
generating a layout representing at least the portion of the property based on the media data captured by the sensor at the plurality of locations within the property, wherein the layout includes the feature mapped to a location within the layout that corresponds to the identified one of the plurality of locations within the property; and
transmitting the layout to a secondary device.
